(19) United States
(12) Patent Application Publication
(10) Pub. No.: US 2004/0078983 A1
(43) Pub. Date: Apr. 29, 2004

(54) Device for cutting grafts

(76) Inventor: Marc Birebent, Tourves (FR)

Correspondence Address: Horst M Kasper, 13 Forest Drive, Warren, NJ, 07059, US

(21) Appl. No.: 10/466,406

(22) PCT Filed: Jan. 16, 2002
(86) PCT No.: PCT/FR02/00172

(30) Foreign Application Priority Data
Jan. 16, 2001 (FR) 0100783

(51) Int. Cl. B26B 13/00

(52) U.S. Cl. 30/233; 30/254

(57) ABSTRACT

The invention provides a device for taking a scion from a scion-source, the device comprising a blade 15 and a bearing plate 7 for pressing against said scion-source, said blade being contained in a cutting plane, said bearing plate forming a longitudinal cutting angle with said cutting plane. Since said cutting angle results from rotation about the cutting edge 16 of the blade, the device includes a member 17 for moving the blade in said cutting plane towards said bearing plate.

The present invention relates to a device for taking a scion from a scion-source.

It seeks in particular to facilitate grafting and double grafting of the kind commonly referred to as shield grafting or eye grafting.

It is therefore applicable to agriculture, in particular to viticulture, arboriculture, and horticulture, serving significantly to reduce the work performed in nurseries and to accelerate fruiting. It also serves to control and facilitate varietal and clonal modifications by avoiding grubbing up, replanting, or retraining plots and orchards.

Grafting operations used to be performed in general in fields. Unfortunately, the cleft grafts made in that way lead to random results, which can be explained in part by a high degree of sensitivity to weather conditions, but above all to the injury caused to the stock. So-called omega- or U-shaped grafts turn out to be poorly adapted to work in the field. As a result, grafting operations are nowadays performed essentially at a work-bench using tools that are expensive and bulky.

Double grafting, i.e. grafting in the field on a portion of a plant that is above the ground, leads to the same difficulties as those mentioned above for grafting. Arboricultural methods of grafting or double grafting known as shield grafting are often identified by various other terms such as eye grafting, shielding, double shielding, veneer grafting, bud grafting, chip budding, T-budding, and various foreign terms. These methods, which are essentially manual, are implemented by means of a conventional grafting knife. They are therefore dangerous and in addition they require a high degree of skill and long experience on the part of the people performing it. Furthermore, the results are not always up to expectations.

Secateur type grafting tools are also known such as those described, for example, in documents DE 11 45 849 and GB 671 852. Those tools cut the scion-source in a plane perpendicular to its axis, thereby tearing plant fibers, and consequently compromising the quality of the grafting.

Thus, an object of the present invention is to provide a device for taking a scion that is easy to handle by people having no special competence, that is sufficiently simple to be suitable for use in any location, and in particular in a field. Furthermore, the device preserves the scion as much as possible.

According to the invention, a device for taking a scion from a scion-source comprises a blade and a bearing plate for pressing against the scion-source, the blade being contained in a cutting plane, the bearing plate forming a longitudinal cutting angle with the cutting plane; in addition, the cutting angle results from rotation about the cutting edge of the blade, and the device includes a member for moving the blade in the cutting plane towards the bearing plate.

The scion-source is thus cut in the direction of the fibers, unlike when using the tools of the two above-cited documents where the cutting angle is defined by rotation about an axis contained in the cutting plane and perpendicular to the cutting edge of the blade.

Advantageously, the bearing plate is provided with an abutment, and it is optionally surmounted by a flexible holding element.

Preferably, the device includes a blade return member and it also includes a sharpening element disposed at the intersection of the cutting plane and the bearing plate.

According to an additional characteristic, the device further comprises at least one guide forming a cross-cut angle with the cutting plane, the displacement member also enabling the blade to be directed towards the guide along the cutting plane.

In a first embodiment, the device comprises two branches, a first branch supporting the bearing plate and a second branch supporting the blade, the second branch, which constitutes the displacement member, being pivotally mounted on the first branch about an axis perpendicular to the cutting plane.

The bearing plate is optionally provided with graduations.

In a second embodiment, the device is constituted by a jig provided with a passage in which the blade is moved in translation, the bearing plate being a wall of a tubular orifice extending from one face of the jig to the passage.

Advantageously, the device includes an extraction duct disposed on the side of the passage opposite from the orifice.

Similarly, the device preferably includes a guide constituted by a second tubular orifice extending from one face of the jig to the passage.

Advantageously, the device includes a recovery duct disposed on a side of the passage opposite from the second orifice.

It is also possible for the displacement member to be motor driven.

The present invention appears in greater detail below in the following description of embodiments given by way of example and with reference to the accompanying figures, in which:

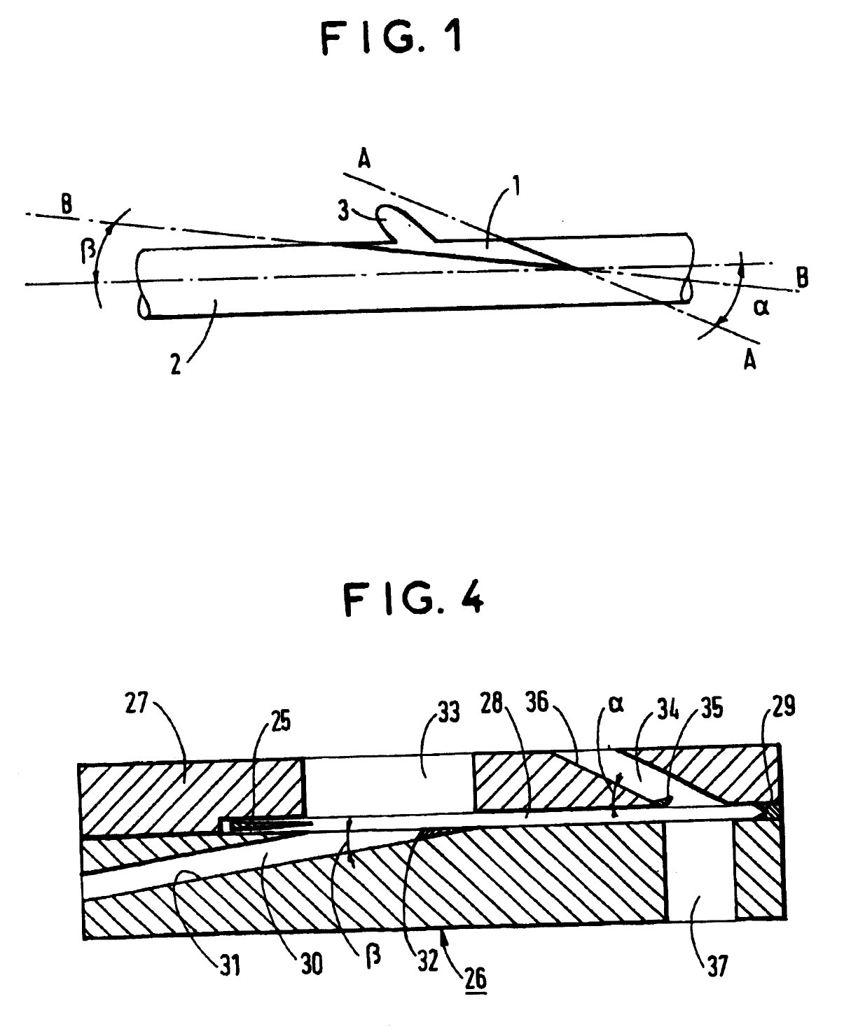

FIG. 1 shows a portion of a scion-source;

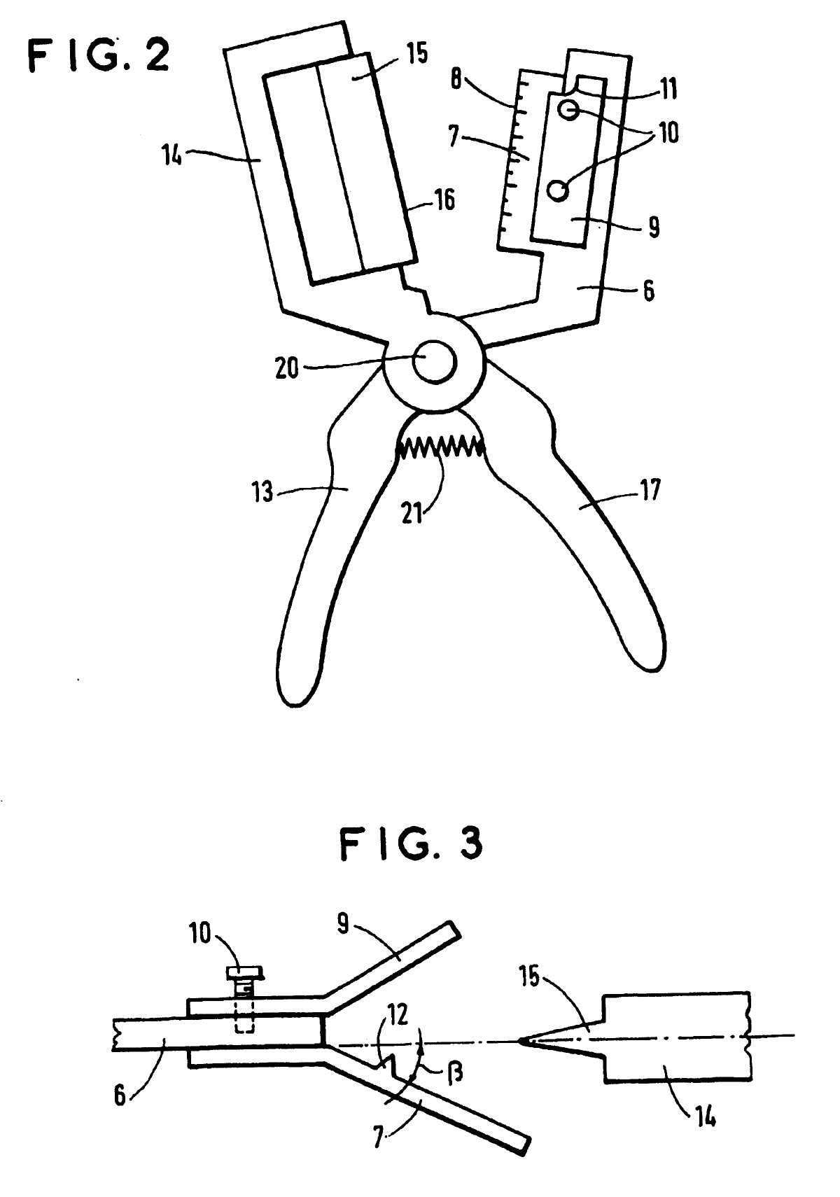

FIG. 2 shows a first embodiment of the device seen in the cutting plane;

FIG. 3 shows the first branch of a device in a front view; and

FIG. 4 shows a second embodiment of the device in a section view.

Elements that appear in more than one figure are given the same reference numeral in all of them.

With reference to FIG. 1, a scion 1 is obtained by making two cuts into a plant stem 2 referred to as a “scion-source”. A cross cut AA is made in a plane forming an angle α of about 25° with the axis of the stem. It begins several millimeters beneath an eye 3 and goes progressively away therefrom. A longitudinal cut BB is made in a plane forming an angle β that is close to 10° to 15° with the axis of the stem. It begins a few millimeters to a few centimeters above the eye 3 and meets the cross cut in the core of the stem. Ideally, the line of intersection between the cross cut and the longitudinal cut passes close to the axis of the stem.

With reference to FIGS. 2 and 3, in a first embodiment of the invention, a device for taking scions is similar to agricultural pruning shears or “secateurs”. It comprises a first branch 6 having a bearing plate 7 fixed thereto which is downwardly inclined at an angle close to the longitudinal angle of cut β. Preferably, this bearing plate 7 is provided with graduations 8 for adjusting the position of the scion-source, in particular as a function of the size desired for the scion.

A scion-holder element 9 is also provided, in this case likewise in the form of a plate fixed by flexible elements 10 to the first branch 6. The flexibility, which is obtained by means of springs for example, enables the scion-source to be wedged between the bearing plate 7 and the holding element 9 and prevents the scion from dropping away at the end of the cutting operation. Because of the presence of this holding element, it can be advantageous to reduce the inclination of the bearing plate 7.

Advantageously, the holding element 9 presents a curved cutout 11 which, in combination with the bearing plate 7, defines a guide of inclination equal to the cross-cut angle α.

At this point it should be observed that other kinds of guide could be arranged by providing other cutouts, for example.

In addition, an abutment 12 is arranged at the intersection between the bearing plate 7 and the holding element 9.

The first branch 6 is terminated by a first handle 13.

The device has a second branch 14 having a removable blade 15 secured thereto which is provided with a cutting edge 16 facing the bearing plate 7. This second branch 14 is terminated by a second handle 17 and it is hinged to the first branch about a hinge pin 20.

The two handles 13, 17 are connected together by a return spring 21 which tends to space them apart so as to make it possible to retrieve the scion once it has been cut off.

The plane of the blade 15 is perpendicular to the hinge pin 20 and defines a cutting plane relative to which the cross and longitudinal cut angles α and β are referenced. More precisely, it can be considered that these two angles are the result of rotation about the cutting edge 16 of the blade 15 when the device is closed, i.e. when the two handles 13 and 17 are as close together as possible.

A scion is taken initially by performing the cross cut. To do this, it is possible to use a grafting knife, but it is also possible to use the above-described device using one hand to press the scion-source against the cutout 11 and the bearing plate 7, and using the other hand to actuate the two handles 13, 17.

Thereafter, the end of the scion-source which has been subjected to the cross cut is inserted against the abutment 12 to press against the bearing plate 7, and the two handles are operated again.

With reference to FIG. 4, in a second embodiment of the invention, the device for taking a scion is in the form of a jig 26 provided with a linear actuator 27 which drives a blade 25. The blade thus moves in translation in a passage 28 which is terminated by a sharpening element 29 such as a sharpening stone.

A first tubular orifice 30 is provided for performing the longitudinal cut, which passage terminates firstly outside the jig and secondly in the passage 28. The bottom wall 31 of said first orifice is provided with an abutment 32 level with the passage 28. It is downwardly inclined at the longitudinal angle of cut β. An extraction duct 33 is provided connecting the passage to the outside of the jig, and is thus disposed on the side of the passage that is opposite from the first orifice. This duct enables the scion to be extracted when the blade 25 has been actuated.

A second tubular orifice 24 is provided to perform the cross cut, which orifice also opens out firstly to the outside of the jig and secondly into the passage 28. optionally, this second orifice is provided with an abutment 35 level with the passage 28. Its bottom wall 36 is downwardly inclined at the cross-cut angle a. A recovery duct 37 is provided connecting the passage to the outside of the jig, i.e. it is disposed on the side of said passage that is opposite from the side on which the second orifice is located. This duct enables the end of the scion-source that is cut off by the blade 25 to be recovered.

Naturally, the actuator 27 could be replaced by a lever so as to enable the blade 25 to be actuated manually.

The embodiments of the invention described above have been selected because of their concrete nature. Nevertheless, it is not be possible to provide an exhaustive list of all embodiments covered by the invention. In particular, any means may be replaced by equivalent means without going beyond the ambit of the present invention.

1. A device for taking a scion from a scion-source, the device comprising a blade (15, 25) and a bearing plate (7, 31) for pressing against said scion-source, said blade being contained in a cutting plane, said bearing plate forming a longitudinal cutting angle with said cutting plane,
the device being characterized in that said cutting angle results from rotation about the cutting edge (16) of the blade, and the device includes a member (17, 27) for moving the blade in said cutting plane towards said bearing plate.

2. A device according to claim 1, characterized in that said bearing plate (7, 31) is provided with an abutment (12, 32).

3. A device according to claim 1 or claim 2, characterized in that said bearing plate (7) is surmounted by a flexible holding element (9).

4. A device according to any preceding claim, characterized in that it includes a blade return member (21, 27).

5. A device according to any preceding claim, characterized in that it includes a sharpening element (29) disposed at the intersection between said cutting plane and said bearing plate (21).

6. A device according to any preceding claim, characterized in that it includes at least one guide (7-11, 34) forming a cross-cut angle with said cutting plane, said displacement member (17, 27) also enabling said blade (15, 25) to be directed towards said guide along said cutting plane.

7. A device according to any preceding claim, characterized in that it comprises two branches, a first branch (6) supporting the bearing plate (7) and a second branch (14) supporting the blade (15), the second branch, which constitutes said displacement member, being pivotally mounted on said first branch about an axis (20) perpendicular to said cutting plane.

8. A device according to claim 7, characterized in that said bearing plate (7) is provided with graduations (8).

9. A device according to any one of claims 1 to 5, characterized in that it is constituted by a jig (26) provided with a passage (28) in which said blade (25) is moved in translation, said bearing plate being a wall (31) of a tubular orifice (30) extending from one face of said jig to said passage.

10. A device according to claim 9, characterized in that it includes an extraction duct (33) disposed on the side of said passage (28) opposite from said orifice (30).

11. A device according to claim 6, characterized in that it is constituted by a jig (26) provided with a passage (28) in which said blade (25) moves in translation, said bearing plate being a wall (31) of a first tubular orifice (30) extending from one face of said jig to said passage, said guide being a second tubular orifice (34) extending from one face of said jig to said passage.

12. A device according to claim 11, characterized in that it includes an extraction duct (33) disposed on a side of said passage (28) opposite from said first orifice (30).

13. A device according to claim 11 or claim 12, characterized in that it includes a recovery duct (37) disposed on a side of said passage (28) opposite from said second orifice (34).

14. A device according to any preceding claim, characterized in that said displacement member is motor driven.
